(19) United States
(12) Patent Application Publication
(10) Pub. No.: US 2025/0165885 A1
(43) Pub. Date: May 22, 2025

(54) Adjusted Schedule Generation Based on Machine-Inferred Constraints

(71) Applicant: ZEBRA TECHNOLOGIES CORPORATION, Lincolnshire, IL (US)

(72) Inventors: Niwedita Dubey, Raleigh, NC (US); Hareesh Babu Annu, Mansfield, MA (US); Sriram Krishnan, Sharon, MA (US)

(21) Appl. No.: 18/515,195

(22) Filed: Nov. 20, 2023

(51) Int. Cl. G06Q 10/0631

(52) U.S. Cl. CPC G06Q 10/063116

(57) ABSTRACT

A method includes: generating, for a target identifier, a plurality of shift candidates, each shift candidate defining values for a set of attributes; generating a metric corresponding to each shift candidate; obtaining a score associated with the target identifier, the score corresponding to a first attribute of the set of attributes; determining a metric adjustment for each shift candidate based on (i) the obtained score for the target identifier, and (ii) a value of the first attribute defined by the shift candidate; selecting a shift candidate for the target identifier, based on the metrics and the metric adjustments; and deploying a schedule containing the selected shift candidate.

### BACKGROUND

The generation of scheduling data, such as a set of shifts for distribution to employees in a retail facility or the like, can be a complex multi-variate process. Despite the complexity of some scheduling mechanisms, however, the schedules generated by such mechanisms may necessitate a variety of changes before or after distribution to employees. Those changes can be time-consuming and error-prone, and may be associated with an inefficient use of computational resources by the scheduling mechanisms.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for adjusted schedule generation based on machine-inferred constraints.

FIG. 2 is a flowchart of a method of adjusted schedule generation based on machine-inferred constraints.

FIG. 3 is a diagram illustrating an example performance of block 205 of the method of FIG. 2.

FIG. 4 is a diagram illustrating an example performance of block 210 of the method of FIG. 2.

FIG. 5 is a diagram illustrating an example performance of classifier generation at block 215 of the method of FIG. 2.

FIG. 6 is a diagram illustrating an example performance of score determination at block 215 of the method of FIG. 2.

FIG. 7 is a diagram illustrating an example performance of blocks 220 and 225 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: generating, for a target identifier, a plurality of shift candidates, each shift candidate defining values for a set of attributes; generating a metric corresponding to each shift candidate; obtaining a score associated with the target identifier, the score corresponding to a first attribute of the set of attributes; determining a metric adjustment for each shift candidate based on (i) the obtained score for the target identifier, and (ii) the value of the first attribute defined by the shift candidate; selecting a shift candidate for the target identifier, based on the metrics and the metric adjustments; and deploying a schedule containing the selected shift candidate.

Additional examples disclosed herein are directed to a computing device, comprising: a communications interface; and a processor configured to: generate, for a target identifier, a plurality of shift candidates, each shift candidate defining values for a set of attributes; generate a metric corresponding to each shift candidate; obtain a score associated with the target identifier, the score corresponding to a first attribute of the set of attributes; determine a metric adjustment for each shift candidate based on (i) the obtained score for the target identifier, and (ii) the value of the first attribute defined by the shift candidate; select a shift candidate for the target identifier, based on the metrics and the metric adjustments; and control the communications interface to deploy a schedule containing the selected shift candidate.

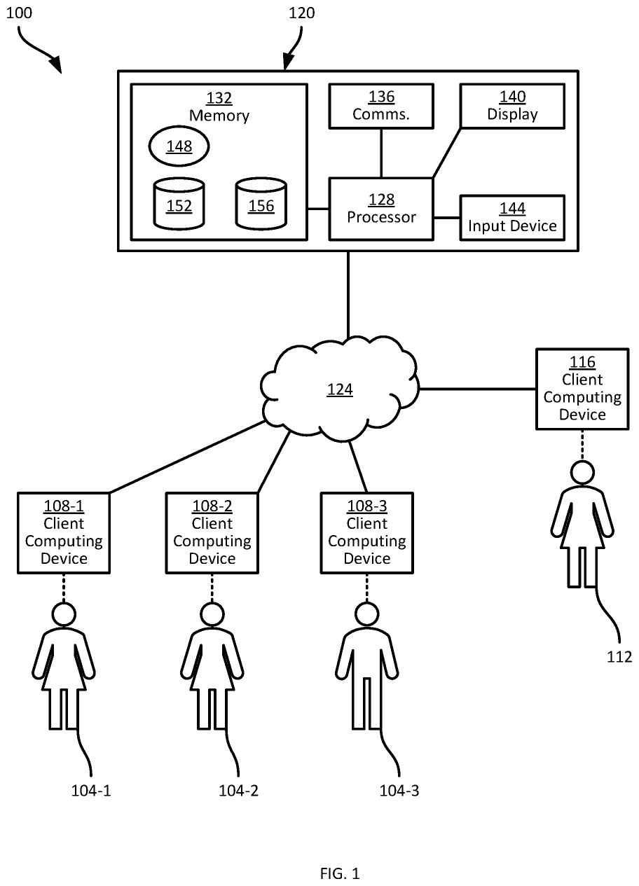

FIG. 1 illustrates a system 100 for adjusted schedule generation based on machine-inferred constraints. The system 100 can be deployed in association with one or more retail facilities, manufacturing facilities, healthcare facilities, or the like, to deploy scheduling data to a plurality of employees in the facility. Three example employees 104-1, 104-2, and 104-3 are shown in FIG. 1, although it will be understood that the system 100 can deploy scheduling data to a greater number of employees than those shown. The employees 104-1, 104-2, and 104-3 may also be referred to below collectively as the employees 104, and any given employee may be referred to generically as an employee 104. Similar nomenclature is used elsewhere herein for reference numbers with hyphenated suffixes.

Deploying scheduling data to the employees 104 includes providing at least some of the employees 104 (e.g., as few as one of the employees 104, and as many as all of the employees 104) with data defining which periods of time those employees are scheduled to work at the facility. Each such period is referred to as a shift. The scheduling data can also define a wide variety of other information, including which task(s) are assigned to the employees during a given shift, which location(s) the employees 104 are assigned to for a given shift, for example if the system 100 manages scheduling for more than one physical facility, and the like.

The complexity of generating scheduling data can increase with the number of employees 104, the size of the facility (e.g., greater labor demands at larger facilities may involve assigning concurrent shifts to larger numbers of employees), the variety of tasks to be performed, and the like. Various systems therefore implement automated schedule generation mechanisms. Such systems consume a variety of inputs corresponding to the employees 104, such as employee type (e.g., full-time or part-time), employee skills and/or certifications, planned employee absences, employee minimum working hours per week, job role, eligibility to perform tasks, seniority, and the like. Such system also consume inputs associated with the facility, such as definitions of labor demand over a planning period. For example, the labor demand can be defined as a number of hours for each of a plurality of tasks to be performed in the facility, for each day (or other suitable period) over a planning period, such as one week. By processing those inputs, automated schedule generation systems seek to generate a set of shifts assigned to at least a portion of the employees 104 over the planning period, optimized according to a variety of factors. Examples of those factors include fulfilling the defined labor demand, reducing or avoiding unassigned time during shifts (e.g., time during which no task is assigned to an employee), and avoiding conflicts with labor laws and scheduling rules (e.g., maximum permitted consecutive working hours, minimum break lengths between shifts, and the like).

A schedule generated by such an automated generation system can be deployed to the employees 104 by, for example, transmitting shift definitions to the employees 104 to whom those shifts are assigned. For example, each employee 104 can operate a respective client computing device 108-1, 108-2, 108-3, such as a smartphone, a tablet computer, or the like. Shifts can be transmitted to the client devices 108 for viewing by the relevant employees via a web browser, a dedicated scheduling application, or the like. The automatically generated schedule can also be provided to an administrator 112, such as a manager of the facility (the facility may have more than one manager in some examples), via a client computing device 116 operated by the administrator 112. The administrator 112 and the employees 104 may, for example, have account credentials or the like permitting access to a web-based application where schedule data can be viewed and/or edited.

In response to the generation of a schedule and the presentation of the schedule to either or both of the employees 104 and the administrator 112 via the client devices 108 and 116, the employees 104 and/or the administrator 112 may request and/or make changes to the schedule. For example, shifts may be moved (e.g., earlier or later in a day), reassigned from one employee 104 to another employee 104, shifts may be added to the schedule or removed from the schedule, and the like. Requesting changes to the schedule (e.g., in the case of the employees 104) reviewing such requests and/or making changes to the schedule (e.g., in the case of the administrator 112) can be time-consuming. In addition, the manual processing of such changes can be error-prone, and may result in a sub-optimal schedule.

The system 100 implements functionality to reduce the volume of changes such as those noted above that are made to a schedule once the schedule has been generated and deployed to the client devices 108 and 116. By reducing the volume of changes, the system 100 may generate schedules with reduced manual involvement by the employees 104 and 112, thus improving the efficiency with which the final schedule is generated, and/or increasing the yield obtained from the computational resources committed to automated schedule generation.

The system 100 includes a computing device 120, such as a server, distributed computing device, or the like, in communication with the client devices 108 and 116 via a network 124 (e.g., a suitable combination of local and wide area networks). To reduce the volume of manually-initiated changes to schedules, the device 120 is configured to infer constraints from events detected in connection with previously-deployed schedules, and to generate further schedules automatically taking the inferred constraints into account.

The changes requested and/or made to a schedule by the employees 104 and the administrator 112 may reflect constraints that are not represented explicitly in the inputs consumed by previous schedule generation mechanisms. Certain constraints are, however, detectable from the changes, and are recurring such that if detected, the constraints can be accounted for in future schedule generation. As one example of such a constraint, the employee 104-2 may have a preference for early-morning shifts. As another example, the administrator 112 may prefer to assign the employee 104-3 to closing shifts (e.g., shifts that encompass the time at which the facility closes for business) due to characteristics of the employee 104-3 that are not captured in employee profile data considered in previous schedule generation mechanisms. The device 120 is configured, as described below, to process changes requested and/or made to schedule data, detect inferable constraints such as the above-noted preferences, and automatically incorporate such constraints into future schedule generation.

The device 120 includes a processor 128 (e.g., a central processing unit (CPU), graphics processing unit (GPU), and/or other suitable control circuitry, microcontroller, or the like), interconnected with a non-transitory computer readable storage medium, such as a memory 132. The memory 132 includes a suitable combination of volatile memory (e.g. Random Access Memory or RAM) and non-volatile memory (e.g. read only memory or ROM, Electrically Erasable Programmable Read Only Memory or EEPROM, flash memory). The memory 132 stores computer-readable instructions, execution of which by the processor 128 configures the processor 128 to perform various functions in conjunction with certain other components of the computing device 120. The computing device 120 also includes a communications interface 136 enabling the device 120 to exchange data with other computing devices such as the client devices 108 and 116, e.g., via the network 124. The device 120 can also include a display 140 and/or other suitable output device. The device 120 can further include an input device 144 such as a keyboard, a mouse, a touch panel or the like.

The instructions stored in the memory 132 include, in this example, a schedule generation application 148 that, when executed by the processor 128, configures the device 120 to generate schedule data. Generation of schedule data can be based on various inputs from a repository 152, such as labor laws, labor demand for the facility, employee profile data such as vacation and/or other absences, skills and certifications, full-time or part-time type indicators, employee minimum working hours per week, job role, eligibility to perform tasks, seniority, and the like.

The application 148 can also configure the processor 128 to process events detected in association with the schedule data to infer constraints as summarized above, and automatically adjust further schedule data. The constraints inferred from event data, also referred to herein as preferences or scores, can be stored in a repository 156 for use in schedule data generation. The device 120 and the application 148 may be referred to in the discussion below as being configured to perform various actions. It will be understood that such references indicate that the device 120 is configured to perform those actions via execution of the application 148 by the processor 128. In some examples, the application 148 can be implemented via a suite of distinct applications, and/or via dedicated control hardware, such as an application-specific integrated circuit (ASIC) or the like.

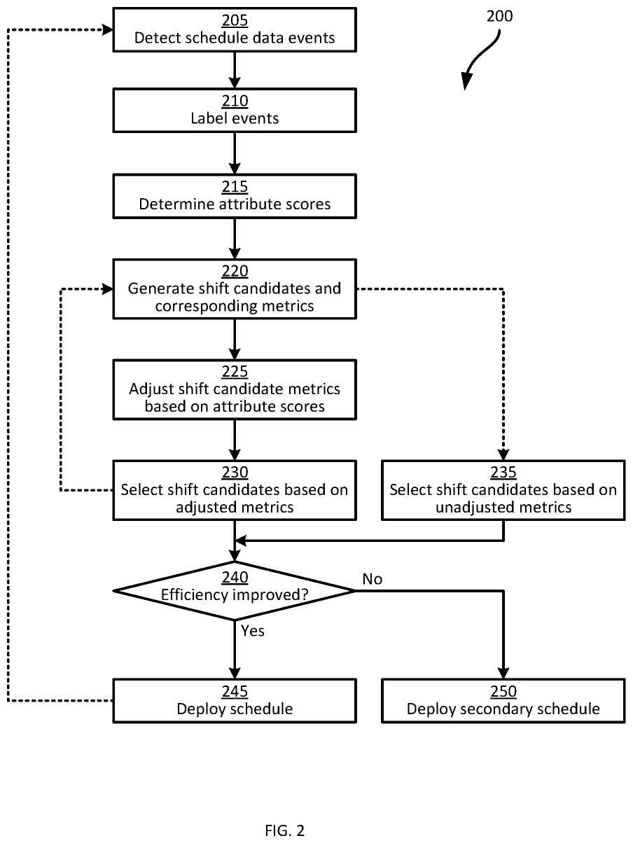

Turning to FIG. 2, a method 200 of generating schedule data adjusted based on inferred constraints is illustrated. The method 200 is described below in conjunction with its performance by the device 120, via execution of the application 148 by the processor 128.

At block 205, the device 120 is configured to detect a plurality of schedule data events. The schedule data events are associated with one or more previously deployed schedules, and reflect any one or more of changes made to the previous schedule(s), requests for changes made to the previous schedule(s), timestamp data associated with the previous schedule(s), and the like. In other words, the events detected by the device 120 at block 205 reflect the constraints mentioned above that are absent from input data to prior schedule generation mechanisms.

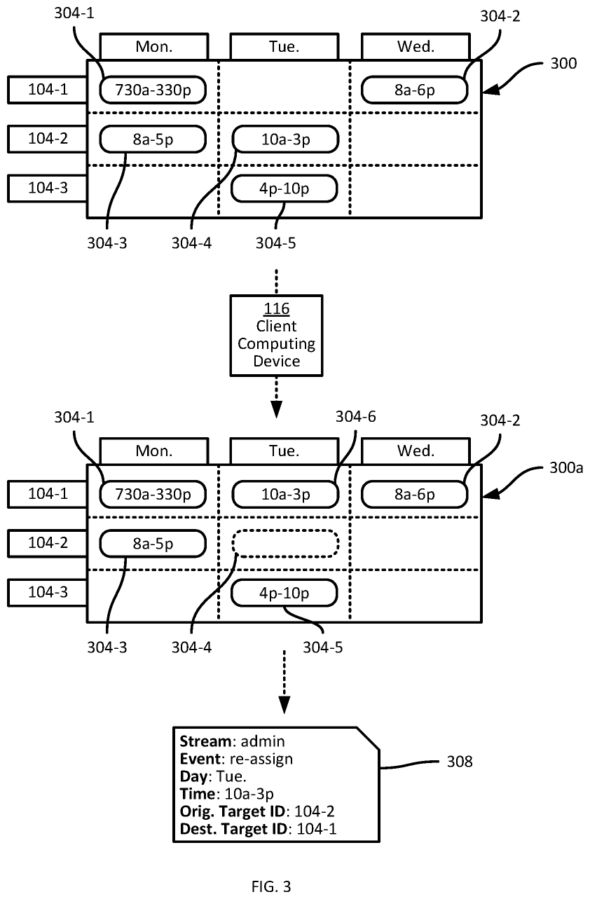

Turning to FIG. 3, an example schedule 300 is illustrated. The schedule 300 may have been previously generated by the device 120 and deployed to the client devices 108 and 116, e.g., defining a set of shifts for the employees 104 over an upcoming week or portion thereof. It will be understood that although the schedule 300 covers three weekdays, schedule data can cover a wide variety of planning periods, including periods shorter than the three days illustrated, and periods longer than the three days illustrated. For example, schedules may be generated for one-week periods (e.g., seven days).

As seen in FIG. 3, the schedule 300 includes a plurality of shift records 304-1, 304-2, 304-3, 304-4, and 304-5. Each shift record 304 is assigned to an employee 104, indicated in FIG. 3 by the position of the shift record 304 in the table. Each shift record 304 defines values for a variety of shift attributes. For example, a shift record 304 can define a start time (e.g., 7:30 am for the shift 304-1), an end time (e.g., 3:30 pm for the shift 304-1), and a day of the week (e.g., Monday for the shift 304-1). Each shift record 304 can also contain various other information not displayed in FIG. 3, such as one or more tasks allocated to the shift, a location (e.g., a particular store among a set of stores covered by the schedule 300), and the like.

The client devices 108 and 116 can receive the schedule 300 or portions thereof, e.g., in messages from the device 120, by retrieving the schedule 300 via a web page or other suitable portal hosted by the device 120, or the like. The employees 104 and/or the administrator 112 can generate events by requesting or effecting changes to the schedule 300. For example, as shown in FIG. 3, the client device 116 (e.g., in response to input data from the administrator 112) can transmit a message to the device 120 to effect a change to the schedule 300, to re-assign the shift 304-4 from the employee 104-2 to the employee 104-1.

The device 120 may apply the re-assignment from the device 116 to obtain a revised schedule 300a, in which the shift 304-4 has been deleted and a shift 304-6 has been added, with the same values as the shift 304-4 excepting a target identifier indicating which employee 104 the shift 304-4 is assigned to. That is, the target identifier of the shift 304-6 corresponds to the employee 104-1, rather than to the employee 104-2.

The device 120 can also, in response to receiving the message from the client device 116 and generating the revised schedule 300a, generate an event record 308. The event record 308 contains data defining the shift 308 affected by the event, such as the day, start time, and end time of the affected shift. The event record 308 also includes, in this example, a stream identifier, indicating whether the event was initiated by the administrator 112 (e.g., the message initiating the event was received from the device 116, or a different computing device in association with account credentials or another identifier corresponding to the administrator 112) or by an employee 104 (e.g., the message initiating the event was received from a device 108, or a different computing device in association with account credentials or another identifier corresponding to that employee 104). As discussed below, the event records 308 generated via block 205 can be processed in two independent streams, to infer constraints associated with administrators, and separate constraints associated with employees 104.

In this example, the event record 308 also includes an event type (indicating that the event is a re-assignment event), and additional attributes that may be specific to the event type (e.g., an originating target identifier and a destination target identifier). The event record 308 can be stored in the repository 156, or in another suitable repository at the device 120 for subsequent processing.

A wide variety of events can be detected via block 205. The events can be detected over a period of time, for example beginning with the deployment of the schedule 300, prior to the start day of the schedule 300, and ending with the completion of the schedule 300, e.g., at the end of the Wednesday shown in FIG. 3. In other examples, the events detected at block 205 can be collected by the device 120 over a plurality of previous scheduled periods (e.g., the period covered by the schedule 300, as well as additional periods covered by additional schedules, for which further events may be detected).

A further example of an event that can be detected by the device 120 is a change to a start time and/or end time of a shift 304, e.g., to lengthen or shorten the shift 304, to move the shift 304 from one day of the week to another, to retain shift length but move the shift 304 earlier or later in the day, or the like. An event record 308 for a time change can include a stream identifier, an event type indicator, time values such as a day, start time, and end time. The event record 308 can include both original and revised values for the attribute(s) affected by the change.

Events can also include an addition of a shift 304 (e.g., a shift 304 not defined in the original schedule 300) or the deletion of a shift 304 from the schedule. The event record 308 representing an addition or a deletion can contain the attributes of the affected shift (e.g., target identifier, time values, task identifiers, and the like), as well as a stream identifier and an event type. Still further example events can include shift swaps, which are effectively bidirectional re-assignments, in which a first shift 304 is reassigned from a first employee 104 to a second employee 104, and a second shift 304 is reassigned from the second employee to the first employee 104.

Further example events can include clock-in and clock-out timestamps, indicating when an employee 104 began and/or ended an assigned shift. The devices 108 can be configured to transmit messages to the device 120 to indicate when the corresponding employee 104 has begun a shift (e.g., in response to input from the employee 104 at the device 108). In some examples, the administrator 112 can review such timestamps, e.g., via the device 112, and correct the timestamps as necessary to align with shift start and end times. For example, the administrator 112 may correct clock-in or clock-out entries that were delayed due to network outages or the like. The event detected at block 205 may therefore be, in some examples, a confirmation received at the device 120 (e.g., from the administrator 112) that clock-in and/or clock-out timestamps have been reviewed and accepted (following correction, as applicable).

When a difference between a scheduled start time and an actual start time exceeds a predetermined threshold (e.g., 10 minutes, although smaller or larger thresholds can also be used), the device 120 can be configured to generate an event record 308.

Events can further include requests for modification of the schedule 300. The employees 104, for example, may submit requests for changes to the schedule 300 via the devices 108, but application of the requested changes to the schedule 300 may be performed by the administrator 112. For example, the device 120, in response to receiving a request from a device 108, may present the request to the device 116, and the administrator 112 can indicate approval or rejection of the request, following which the requested change can be implemented or discarded at the device 120. Whether a requested change is approved or denied, however, the device 120 can also generate an event record 308 for the change.

Examples of change requests captured as event records 308 include re-assignment requests, shift addition requests, shift time change requests, and the like. The event record 308 generated in response to a request may be updated in response to further messages received at the device 120. For example, a shift re-assignment request may be transmitted to the device 108 corresponding to the intended recipient of the shift 304, and the corresponding employee 104 can accept or reject the re-assignment. In some examples, the request can also be transmitted to the device 116 for approval or rejection by the administrator 112. The corresponding event record 308 can be updated to reflect whether the request was approved or rejected (either by the intended recipient employee 104, the administrator 112, or both). As will be apparent, certain sequences of events may result in the generation of multiple event records 308.

The performance of block 205 can continue for a predetermined period of time, and/or until a predetermined number of event records 308 have been collected. Returning to FIG. 2, at block 210, the device 120 is configured to determine a label for each event record 308. The labels assigned to the event records 308 are determined automatically by the device 120 according to one or more predetermined criteria. Each label indicates a preference or bias inferred from the event record. In the present example, the device 120 is configured, at block 210, to assign either a positive preference or bias, or a negative preference or bias, to each event record 308.

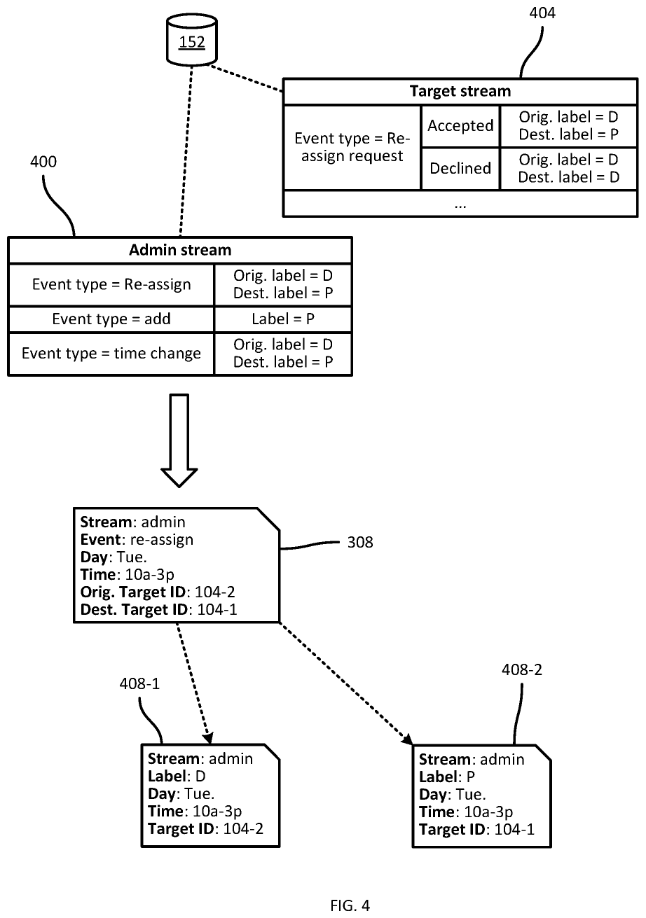

Referring to FIG. 4, an example performance of block 210 is illustrated, for the event record 308 shown in FIG. 3. The device 120 can maintain, for example in the repository 152, criteria for application to the event records 308 to determine labels for the event records 308. The criteria, in this example, include criteria 400 corresponding to event records 308 with the administrator stream identifier, and criteria 404 corresponding to event records 308 with the target stream identifier. In other examples, at least some of the criteria 400 and 404 can be shared between administrative and target-stream event records 308. The criteria 400 can include a plurality of conditions, such as whether an event record 308 has a particular event type. For each condition, the criteria 400 define one or more labels. For example, an event record 308 with the type “re-assign” corresponds to two labels: a label indicating negative bias corresponding to the originating target identifier of the re-assignment, and a label indicating positive bias corresponding to the destination target identifier of the re-assignment.

As shown in FIG. 4, the example event record 308 introduced in FIG. 3 is of the type “re-assign”, and therefore satisfies the first criterion listed in the criteria 400. The device 120 can be configured to generate one or more labelled shift records based on the criteria 400. In this example, the device 120 generates a first labelled shift record 408-1, and a second labelled shift record 408-2. Each labelled shift record 408 includes at least some of the values from the corresponding event record 308. For example, the labelled shift records 408 can include shift timing information (e.g., weekday, start time, and end time), as well as a target identifier, one or more task identifiers allocated to the underlying shift 304, and the like. As seen in FIG. 4, the labelled shift records 408 also include labels. The record 408-1, specifically, includes a label “D”, indicating “does not prefer”, or a negative bias. A wide variety of other label syntaxes can also be employed. For example, a label indicating negative bias can have a numerical value, such as −1. The record 408-2 includes a label “P” indicating “prefers”, or a positive bias. The label “P” can be substituted with a numerical value such as 1 in other examples.

The negative bias label of the record 408-1 indicates that the re-assignment captured in the event record 308 indicates that the administrator 112 (because the event record 308 is an administrator-stream event record 308) does not prefer a shift 304 with the illustrated timing for the employee 104-2. The positive bias label of the record 408-2 indicates that the administrator 112 does prefer a shift 304 with the illustrated timing for the employee 104-1.

As seen from the criteria 400, the device 120 may generate one labelled shift record 408 for an event record 308 defining and added shift, with a “P” label indicating that the administrator 112 has a positive bias towards the corresponding shift (e.g., defined by timing values, task identifiers and a target identifier). Other event records 308, such as an event record indicating a time change to a shift 304, lead to the generation of two labelled shift records 408 as indicated by the third entry in the criteria 400. An example target stream criterion indicates that, for a requested re-assignment, the labelled shift records 408 generated depend on the response to the request. For example, if the employee 104-2 requests a shift re-assignment to the employee 104-1, the resulting labelled shift records 408 indicate that the employee 104-2 has a negative bias against the original shift 304, and indicate a bias for the recipient that depends on whether the recipient accepted the shift re-assignment.

Further examples can include, for example, criteria for a shift swap request. Such criteria may indicate that if the request is accepted by the recipient, three labelled shift records are generated. For example, the employee 104-3 may request a swap of the shift “A” (initially assigned to the employee 104-3) with the shift “B” (initially assigned to the employee 104-1). If the request is accepted by the employee 104-1, the device 120 may generate a first labelled event record with the values of the original shift A and a negative bias label, a second labelled event record with the values of the re-assigned shift B (e.g., including the target identifier 104-3) and a positive bias label, and a third labelled event record with the values of the re-assigned shift A (e.g., including the target identifier 104-1) and a positive bias label.

As will now be apparent, a wide variety of other criteria can also be stored in the repository 152 to generate labelled shift records 408. In general, each criterion can lead to the creation of a labelled shift record 408 indicating positive bias for the result of a change (or the requested result, as applicable) to a shift 304, and negative bias for the original version of the shift 304.

Because the exact circumstances under which the changes or requested changes defined in the event records 308 may not be known to the device 120, the bias values that each individual labelled shift record 408 contain may not all reflect actual persistent preferences or biases of the corresponding employees or administrator 112. Referring again to FIG. 2, at block 215 the device 120 is configured to process the plurality of labelled shift records from block 210 to determine scores indicating inferred biases or preferences that are more likely than an individual labelled shift record to indicate persistent preferences. That is, at block 215 the device 120 is configured to infer biases from the labelled shift records 408 in aggregate. The performance of block 215 (facilitated by the performances of blocks 205 and 210) permits the device 120 to automatically determine the above-mentioned biases. Although the events detected at block 205 may also be stored in previous systems, the variable nature of the events may prevent such systems from automatically processing the events to infer biases. The performance of blocks 205-215, based on the labelling criteria 400 and/or 404, resolves the technical limitations of previous systems by facilitating automated event processing and bias inference.

To perform block 215, the device 120 is configured to generate and/or train at least one classification model, also referred to below as a classifier, using the labelled shift records 408 resulting from the performance of block 210. The device 120 is then configured to execute the classifier (or each classifier, if more than one classifier is generated) to generate a score for one or more values of corresponding shift attributes. A given score indicates at least one of a direction and a magnitude of bias (e.g., whether a preference is positive or negative, and the strength or weakness of that preference) corresponding to a particular value of a shift attribute for a target identifier. As a specific example, the device 120 can generate a classifier configured to accept as input a target identifier and a weekday, and to output a score indicating whether that target identifier is likely to exhibit a bias towards or away from shifts 304 on that weekday, and in some examples how strong the bias is.

The device 120 can be configured, in some examples, to generate a plurality of classifiers, each configured to generate scores for corresponding attributes. For example, in some implementations the device 120 is configured to generate and execute five classifiers, corresponding to shift start time, shift end time, shift weekday, task identifiers, and intraday time periods (e.g., corresponding to one-hour time periods). The device 120 can further be configured to generate two sets of classifiers, with one set being trained or generated with administrative-stream event data, and the other set being trained or generated with target-stream event data. In other words, the device 120 can generate two classifiers corresponding to each attribute.

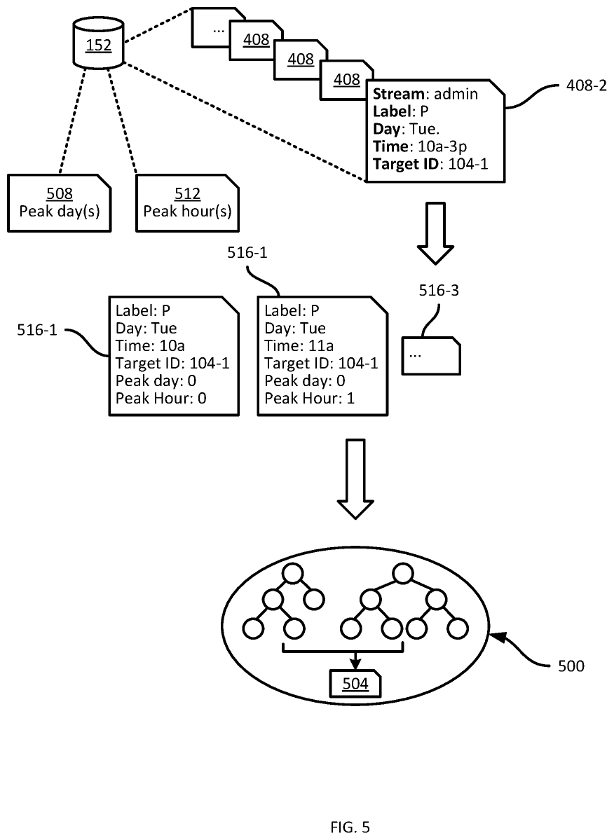

Turning to FIG. 5, an example classifier generation process during the performance of block 215 is illustrated. FIG. 5 illustrates the generation of a classifier 500 for scoring values of intraday periods of time, such as one-hour periods. That is, the classifier 500 is configured to accept input defining at least a target identifier and a one-hour period of a given weekday, and to generate a score 504 indicating whether that period is preferred or not preferred in association with the target identifier. As discussed below, the classifier 500 can be configured to accept inputs defining multiple periods, in some cases for multiple target identifiers, and to generate a corresponding number of outputs 504.

To generate the classifier 500, the device 120 is configured to retrieve the labelled shift records 408, e.g., with the administrative stream identifier. This process can be repeated with target-stream records 408 to generate a further classifier for intraday periods corresponding to employee-initiated events, rather than administrator-initiated events. The device 120 can also retrieve additional data from the repository 152, such as peak day definitions 508 indicating one or more peak demand days of the week, and/or peak hour definitions 512 indicating one or more peak demand hours, e.g., for each day of the week.

The device 120 is configured to extract at least a subset of the values from each labelled shift record 408. Which values are extracted is dependent on which classifier is to be generated. For example, to generate the classifier 500, the labels, weekdays, times (e.g., start and end times), and target identifiers are extracted. Other values, such as task identifiers, may be omitted. From the extracted values, the device 120 can generate feature sets 516-1, 516-2, 516-3, and the like, each representing one hour (or other suitable time period) of the shift represented by the record 408-2. The record 408-2 may, for example, lead to the generation of five feature sets 516. Various other mechanisms of generating feature sets can also be implemented, and in some examples the device 120 can generate a feature set representing multiple time periods.

The device 120 can be configured to repeat the above process for each record 408, generating a plurality of feature sets each representing a given one-hour period and labelled according to the label assigned to the underlying record 408 at block 210. The plurality of feature sets 516 is the training data used to generate the classifier 500. In some examples, the device 120 can also be configured to generate additional synthetic training data, representing time periods for which no feature sets 516 have been created (e.g., for time periods not represented in the records 408). The synthetic feature sets can be generated for each target identifier, and can have a third label indicating an unknown bias (e.g., “N” for neutral, or a numerical value of zero).

In this example, the classifier 500 is a random forest classifier. The device 120 is configured to generate a plurality of trees based on randomly selected samples from the training data, based on hyperparameters such as a number of trees, a maximum tree depth, and the like. Generating the classifier 500 can include tuning the above hyperparameters and regenerating the trees based on the tuned hyperparameters, as will be apparent to those skilled in the art.

The above process can be performed to generate additional classifiers corresponding to other attributes. The attributes extracted from the records 408 for generating each classifier can vary. For example, to generate a classifier configured to generate scores corresponding to task identifiers (e.g., for tasks such as cashiering, bagging, or the like) the device 120 can be configured to extract target identifiers and task identifiers from the records 408, but to omit shift start and end times and days of the week. In other examples, a classifier configured to generate scores for task identifiers can also consume days of the week as input, e.g., to generate weekday-specific scores for each task identifier.

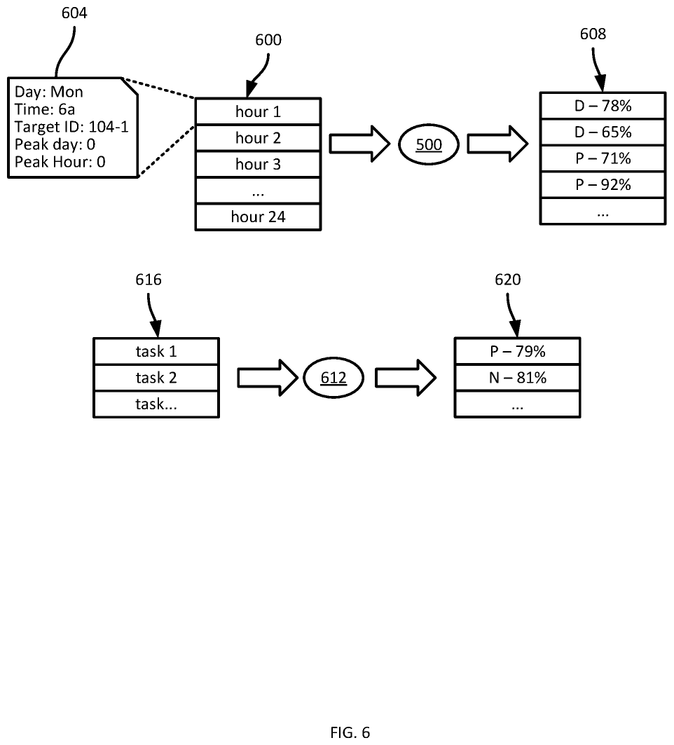

In response to generating a classifier, the device 120 is configured to execute the classifier to generate scores, for each target identifier, for a plurality of values corresponding to a given attribute. For example, turning to FIG. 6, the device 120 can be configured to generate input data 600 for the classifier 500 defining, for example, a set of input vectors corresponding to respective hours of a day, and to a target identifier. In some examples, the device 120 can generate input corresponding to each hour, for each weekday, for each target identifier (e.g., a set of twenty-four inputs for each of the seven weekdays, for each target identifier). Each input vector 604 defines a time period (e.g., a day of the week and an hour of that day), as well as the peak values noted earlier (e.g., in binary form, with zero indicating non-peak and one indicating peak) and a target identifier. As seen in FIG. 6, the input 604 does not include a label. The classifier 500 is configured to generate output data 608 including, for each vector 604 in the input data 600, a bias value (e.g., P for prefers, D for does not prefer, or N for neutral). The scores generated by the classifier can also include, as shown in FIG. 6, a probability or other magnitude indicator, such as a percentage, with higher percentages indicating a greater confidence by the classifier 500 in the bias value. The score for each time period can include the bias values and the corresponding probabilities.

As will be apparent, the classifier 500 can be configured to generate, whether through one processing operation or multiple, seven groups of twenty-four scores for each target identifier. In some examples, the scores generated via execution of the classifier 500 can be presented on the display 140 and/or a display of the device 116 or any of the devices 108, e.g., as a list, a heatmap for a given target identifier, or the like.

The device 120 can also be configured to execute further classifiers to generate scores corresponding to other attributes, in some examples. For example, as shown in FIG. 6, the device 120 can generate a classifier 612, e.g., another random forest classifier, configured to generate scores corresponding to task identifiers. The device 120 can execute the classifier 612 with input data 616 including each of a plurality of task identifiers, for each target identifier, and to obtain scores 620 (e.g., one score per task identifier, per target identifier). The scores generated by the classifier(s) can be stored in the repository 156. Each score can be stored in association with a corresponding target identifier, the attribute value for which the score was generated, and if streaming of event data is implemented, a stream identifier.

Returning to FIG. 2, at block 220 the device 120 is configured to generate shift candidates for a new schedule. The device 120 can also be configured to generate a metric for each shift candidate, such as a cost metric. The performance of block 220, and the subsequent blocks of the method 200, need not be initiated in direct response to the performance of block 215. In some examples, blocks 205, 210, and 215 can be performed independently of the remainder of the method 200, and the remainder of the method 200 can be performed multiple times (e.g., to generate a plurality of schedules), before blocks 205-215 are repeated.

The generation of shift candidates and metrics at block 220 can be performed according to any suitable shift generation mechanism. For example, as will be understood by those skilled in the art, employee profile data and labor demand can be retrieved from the repository 152 and/or received as input data (e.g., from the input device 144, the device 116 via the network 124, or the like). The device 120 can also retrieve labor laws and/or other predetermined scheduling rules. The device 120 can then be configured to sort each target identifier according to parameters from the employee profile data, e.g., including seniority, type (e.g., full-time or part-time) and the like. Beginning with the top-sorted target identifier, the device 120 can be configured to generate a plurality of shift candidates (e.g., all possible shift candidates that comply with the scheduling rules and/or other constraints defined in the input data, such as labor laws, meal break rules, shift length policies, and the like). The device 120 is further configured to assign one or more tasks from the labor demand to each shift candidate.

The device 120 is then configured to determine a metric, such as a cost, for each shift candidate. The cost can be determined by summing rewards and penalties based on various predetermined conditions. Examples of reward conditions include satisfying demand for tasks, meeting minimum coverage requirements defined in the labor demand, covering peak demand hours, and the like. Examples of penalty conditions include portions of a shift candidate that do not have assigned tasks (e.g., idle time during a shift candidate), transitions between tasks occurring during a shift candidate (e.g., instead of a shift candidate being fully covered by a single task), and the like.

Rather than selecting a shift candidate with the lowest cost metric for the current target identifier (e.g., for each day of the week and/or until labor demand is met), and processing the next target identifier as described above, at block 225 the device 120 is configured to determine metric adjustments for each shift candidate from block 220. The metric adjustments determined at block 225 are based on the scores from block 215. For example, to compute a metric adjustment for a shift candidate, the device 120 can retrieve the scores for the relevant target identifier that correspond to the values of the shift candidate. The device 120 can generate adjustment portions for each value based on the bias value (e.g., P or 1, N or 0, or D or −1) and the probability or confidence associated with the bias value. A bias value of 1 and a probability of 78%, for example, may lead to an adjustment portion of 0.78. In some examples, the adjustment portion can also be based on weighting parameters, as discussed below. The device 120 can be configured to sum the adjustment portions for a given shift candidate to obtain the metric adjustment for that shift candidate.

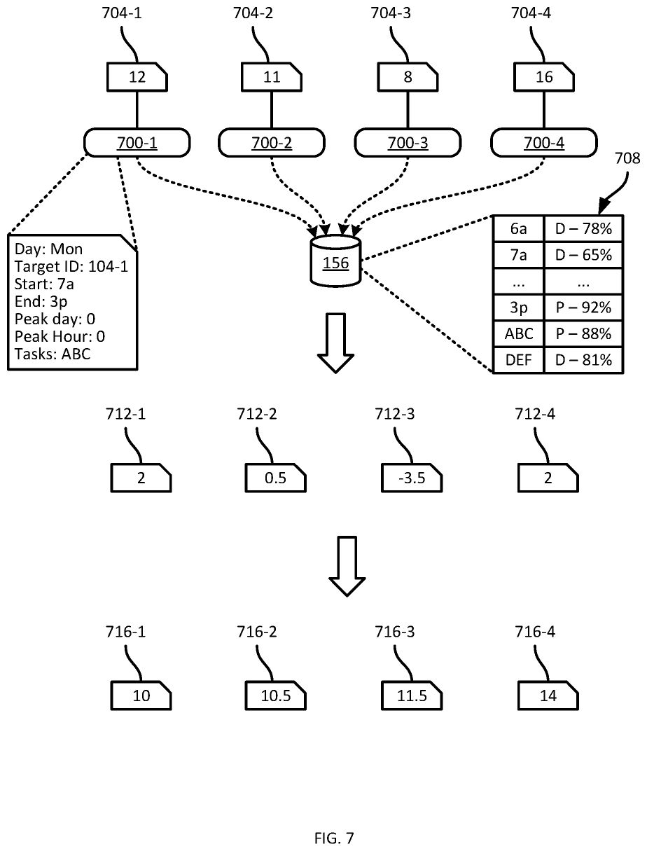

Turning to FIG. 7, an example performance of blocks 220 and 225 is illustrated. The device 120 generates shift candidates 700-1, 700-2, 700-3, and 700-4 corresponding to the target identifier 104-1. Each shift candidate 700 is associated with a cost metric 704-1, 704-2, 704-3, and 704-4. Example values for the shift candidate 700-1 are illustrated, indicating that the shift candidate 700-1 occurs between 7 am and 3 pm on a Monday, and is assigned a task “ABC”. To generate a metric adjustment for the shift candidate 700-1, the device 120 is configured to retrieve scores 708 from the repository 156. The scores 708 correspond to the target identifier 104-1, and define bias values and probabilities for one-hour periods, as well as for task identifiers. The device 120 can, for example, average the scores for the hours that fall within the shift candidate 700-1. The device 120 can then sum the averaged hourly score (e.g., 1.12), as well as the score for the task ABC (e.g., 0.88), to obtain a metric adjustment 712-1 corresponding to the shift candidate 700-1. The device 120 performs the above process to obtain metric adjustments 712-2, 712-3, and 712-4 for the remaining shift candidates 700, applying the scores corresponding to the values of those shift candidates 700. Although two attributes (intraday time periods and task identifiers) contribute to the metric adjustments 712 in this example, in other examples the device 120 can generate fewer (e.g., one) or more than two classifiers, and one or more attributes can therefore contribute to the metric adjustments.

The device 120 can then determine adjusted metrics 716-1, 716-2, 716-3, and 716-4, e.g., by subtracting the adjustments 712 from the metrics 704. In other examples, e.g., if the metrics 704 represent rewards rather than costs, the metric adjustments 712 may be added to the metrics 704.

In some examples, where two classifiers are generated for a given attribute based on the administrative-stream event data and the target-stream event data, the scores in the repository 156 may include two scores per target identifier, per value. For example, the repository 156 may contain, for the target identifier 104-1, a first score corresponding to the task ABC and derived from administrative-stream event data, and a second score corresponding to the task ABC and derived from target-stream event data. The device 120 can determine two distinct metric adjustments based on the two scores. The metric adjustments can then be combined to form the metric adjustment 716-1, for example, by weighted average. For example, the repository 152 can include weighting parameters defining the relative importance of administrative-stream scores and target-stream scores.

Returning to FIG. 2, at block 230 the device 120 is configured to select one or more shift candidates based on the adjusted metrics 716. For example, the device 120 can be configured to select, from the shift candidates 700, the shift candidate with the lowest adjusted metric (e.g., the lowest adjusted cost). The adjustment and selection process can be repeated for other days in the planning period of the schedule, and for other target identifiers, e.g., until the specified labor demand for the schedule is met. For example, the device 120 can repeat blocks 220 to 230 for each target identifier, in the sorted order mentioned above, until the labor demand is met. In some examples, the performance of blocks 220-230 can be phased, such that blocks 220-230 are first performed for target identifiers for which scores are available in the repository 156. If labor demand remains, the device 120 can then perform block 220 for target identifiers for which no scores are available in the repository 156. Blocks 225 and 230 can be omitted for target identifiers without scores. Instead, for those target identifiers the device 120 can proceed to block 235, and select shift candidates based on the unadjusted metrics from block 220. The adjustment of shift candidate metrics as described above overcomes certain technical limitations of prior systems. In such systems, processing additional inputs such as the biases represented by attribute scores from block 215 may require additional configuration and computational load, e.g., to expand the set of inputs consumed at block 220 to generate shift candidates. The device 120, by applying adjustments to shift candidates at block 225, reduces the complexity of shift candidate generation at block 220.

When all labor demand has been satisfied, and/or when all target identifiers have been processed, the schedule is complete and can be deployed. The device 120 can be configured, before deploying the schedule, to compare an efficiency or other suitable performance metric of the new schedule with an efficiency metric of a schedule based solely on unadjusted metrics. For example, even for shift candidates for target identifiers with available scores, the device 120 can be configured to perform both blocks 230 and 235, to generate a schedule using adjusted metrics, and a schedule using unadjusted metrics. As seen from FIG. 7, the adjusted schedule includes the shift candidate 700-1, while the unadjusted schedule includes the shift candidate 700-3.

The device 120 can be configured to compare the schedules resulting from blocks 230 and 235 by, for example, determining what portion of a total number of hours represented by the labor demand (provided as input to the schedule generation process) are covered by each schedule. The coverage provided by each schedule represents the efficiency of that schedule. For example, if the adjusted schedule has a coverage of 98%, and the unadjusted, or secondary, schedule has a coverage of 85%, the determination at block 240 is affirmative. When the determination at block 240 is affirmative, at block 245 the device 120 is configured to deploy the schedule from block 230, e.g., by presenting the schedule on the display 140, transmitting the schedule to the devices 108 and/or 116, or the like.

When the coverage provided by the unadjusted schedule is greater than the coverage provided by the adjusted schedule, the device 120 is configured to proceed to block 250, and deploy the unadjusted schedule instead of the adjusted schedule. In some examples, the device 120 can omit the determination at block 240, and present both adjusted and unadjusted schedules to the administrator 112, e.g., for selection of a schedule to deploy. The device 120 can be configured to perform various optimizations on the schedules prior to deployment at block 245 or 250. For example, the device 120 can be configured to compare a schedule to one or more budgets, and to discard one or more shifts, e.g., if a monetary cost associated with the schedule exceeds a financial budget, and/or if a time cost (e.g., total scheduled hours) exceeds a time budget.

Following deployment of a schedule at either of blocks 245 and 250, the device 120 can return to block 205 and collect further event data, e.g., reflecting changes or requested changes to the schedule deployed at block 245 or block 250. The device 120 can retrain or regenerate the classifiers from block 215 based on such additional event data, for use in future schedule generation processes. Via performance of the method 200, the device 120 may reduce the time and resources consumed by editing schedules.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
generating, for a target identifier, a plurality of shift candidates, each shift candidate defining values for a set of attributes;
generating a metric corresponding to each shift candidate;
obtaining a score associated with the target identifier, the score corresponding to a first attribute of the set of attributes;
determining a metric adjustment for each shift candidate based on (i) the obtained score for the target identifier, and (ii) a value of the first attribute defined by the shift candidate;
selecting a shift candidate for the target identifier, based on the metrics and the metric adjustments; and
deploying a schedule containing the selected shift candidate.

2. The method of claim 1, wherein obtaining the score includes:
detecting a plurality of events corresponding to previous shifts associated with the target identifier in a previous schedule;
determining a label for each of the events;
generating a classification model based on (i) the labels and (ii) values for the first attribute from the previous shifts; and
executing the classification model to determine the score.

3. The method of claim 2, wherein the plurality of events includes a first set of events initiated by the target identifier, and a second set of events initiated by an administrator identifier; and
wherein generating the classification model includes:
generating a first classification model from the first set of events, and a second classification model from the second set of events.

4. The method of claim 3, wherein obtaining the score comprises obtaining a first score via execution of the first classification model, and obtaining a second score via execution of the second classification model; and
wherein determining the metric adjustment is based on (i) the first score, (ii) the second score, (iii) respective weights corresponding to the first and second scores, and (iv) the value of the first attribute.

5. The method of claim 2, wherein each event corresponding to a previous shift is selected from the group consisting of:
a modification of at least one attribute of the previous shift;
a request for assignment of the previous shift to or from the target identifier;
an assignment of the previous shift to or from the target identifier; and
timestamps associated with the previous shift and the target identifier.

6. The method of claim 2, wherein determining a label for each of the events includes:
comparing the event to a labelling criterion corresponding to the event;
assigning a first label when the event satisfies the labelling criterion; and
assigning a second label when the event does not satisfy the labelling criterion.

7. The method of claim 1, further comprising, prior to deploying the schedule:
generating a secondary schedule by selecting a shift candidate for the target identifier based on the metrics;
comparing an efficiency of the schedule with an efficiency of the secondary schedule; and
determining that the efficiency of the schedule exceeds the efficiency of the secondary schedule.

8. A computing device, comprising:
a communications interface; and
a processor configured to:
generate, for a target identifier, a plurality of shift candidates, each shift candidate defining values for a set of attributes;
generate a metric corresponding to each shift candidate;
obtain a score associated with the target identifier, the score corresponding to a first attribute of the set of attributes;
determine a metric adjustment for each shift candidate based on (i) the obtained score for the target identifier, and (ii) a value of the first attribute defined by the shift candidate;
select a shift candidate for the target identifier, based on the metrics and the metric adjustments; and
control the communications interface to deploy a schedule containing the selected shift candidate.

9. The computing device of claim 8, wherein the processor is configured to obtain the score by:
detecting a plurality of events corresponding to previous shifts associated with the target identifier in a previous schedule;
determining a label for each of the events;
generating a classification model based on (i) the labels and (ii) values for the first attribute from the previous shifts; and
executing the classification model to determine the score.

10. The computing device of claim 9, wherein the plurality of events includes a first set of events initiated by the target identifier, and a second set of events initiated by an administrator identifier; and
wherein the processor is configured to generate the classification model by:
generating a first classification model from the first set of events, and a second classification model from the second set of events.

11. The computing device of claim 10, wherein the processor is configured to obtain the score by obtaining a first score via execution of the first classification model, and obtaining a second score via execution of the second classification model; and
wherein the processor is configured to determine the metric adjustment based on (i) the first score, (ii) the second score, (iii) respective weights corresponding to the first and second scores, and (iv) the value of the first attribute.

12. The computing device of claim 9, wherein each event corresponding to a previous shift is selected from the group consisting of:
a modification of at least one attribute of the previous shift;
a request for assignment of the previous shift to or from the target identifier;
an assignment of the previous shift to or from the target identifier; and
timestamps associated with the previous shift and the target identifier.

13. The computing device of claim 9, wherein the processor is configured to determine a label for each of the events by:
comparing the event to a labelling criterion corresponding to the event;
assigning a first label when the event satisfies the labelling criterion; and
assigning a second label when the event does not satisfy the labelling criterion.

14. The computing device of claim 8, wherein the processor is further configured to, prior to deploying the schedule:
generate a secondary schedule by selecting a shift candidate for the target identifier based on the metrics;
compare an efficiency of the schedule with an efficiency of the secondary schedule; and
determine that the efficiency of the schedule exceeds the efficiency of the secondary schedule.
